(19) United States
(12) Patent Application Publication
(10) Pub. No.: US 2005/0014585 A1
(43) Pub. Date: Jan. 20, 2005

(54) Combined out-in stroke mechanical transmission for facilitating and multiplying the speed of cycles and other pedal appliances

(76) Inventor: Georges Nicolas Vaskas, Cagnes Sur Mer (FR)

Correspondence Address: YOUNG & THOMPSON, 745 SOUTH 23RD STREET, 2ND FLOOR, ARLINGTON, VA, 22202, US

(21) Appl. No.: 10/493,206

(22) PCT Filed: Oct. 23, 2001
(86) PCT No.: PCT/FR01/03282

(30) Foreign Application Priority Data
Oct. 27, 2000 (FR) 00/13785

(51) Int. Cl. F16H 55/12

(52) U.S. Cl. 474/81; 474/160

(57) ABSTRACT

Combined input-output mechanical transmission to facilitate and multiply the speed of cycles and other pedaled systems.

Designed to limit the amount of rotation of the pedal mechanism and the force on the pedals whilst multiplying the speed, the invention consists in a combination of transmission elements running from a first multiplying engagement element (A2RL) mounted free wheeling (3) on the axle of the pedal mechanism which drives with its rotation by the movement of the pedals in the advancing direction, by passing through intermediate elements (B, C, . . . ) of multiplying engagement constituted by concentric toothed wheels turning on axles fixed in a chassis connected to the frame, up to the last pinion (Z2), fixed on the hub of the rear wheel so as to turn with it and to take advantage, by the acquired speed, of its lever effect to return the energy by the same gearing to free the axle of the pedal mechanism by the free wheel effect (3) thereby to relieve the pedaling. It replaces the conventional chain transmission or more often takes over from it by clutching when it is mounted in parallel. The invention relates to the industry of cycles and other locomotion means.

The present invention, adaptable to cycles, particularly bicycles, and other locomotion means and pedaled apparatus, relates to a multiplying input-output transmission mechanism formed by a new combination which permits recycling a portion of the energy between the pedal mechanism and the rear wheel so as to limit the amount of rotation of the pedal mechanism and the force on the pedals whilst multiplying the speed.

The traditional means of increasing the speed of cycles, provided most often with a chain transmission running from the pedal mechanism with one or several plates to an assembly of pinions on the hub of the rear wheel, is to use different ratios with mechanical or electromechanical speed change mechanisms giving different gears which permit, particularly for couriers, to reach speeds of 50 to 60 km/h. Except for costly additions of auxiliary energy, either electrical or by combustion engine which are most often noisy and polluting, it is also well known that such speeds require a substantial muscular output, which is a cause of fatigue and that the mechanical means to reduce it which consist in storing energy in resilient means thereafter to restore it, in the ergonometry of the frame, that of the pedal mechanism, in the plates or the intermediate gears and other systems of transmissions, etc., have limited effects.

Adaptable to any type of cycle, the transmission according to the invention, a new combination of engagement elements in which the energy circulates by input-output, with application of the pressure power of the feet of the user on pedals to rotate the rear wheel and to return the speed acquired by the rear wheel to decrease the necessary pressure on the pedals, has the advantage, because of the return to the pedal mechanism of an important part of the inertial energy, while requiring much less muscular force, such that, according to the ratio of multiplying engagements, the number of pedal turns to be effected to reach similar speeds is much less than according to the conventional single transmissions; and the speed of recycling provided with this new transmission can, as desired by the user who controls continuous acceleration, greatly exceed or multiply the current speeds to approach those of motor vehicles, without excessive fatigue, without noise, without fuel, and hence without pollution.

This input-output transmission mechanism, from the pedal mechanism to the rear hub, combines a series of transmission elements for engagement, reinforced by complementary toothed wheels or crowns to facilitate pedaling and increase of speed.

Driven when pedaling takes place in the direction of advancement and free in the other direction, the first element of the series of transmission elements by engagement is constituted by a toothed wheel associated with the axle of the pedal mechanism, on which are fixed cranks with their pedals, by a free wheel of the one-way direction type mounted often on a region of enlarged diameter. It engages with the series of intermediate transmission elements which are of multiplying engagement (whose number, more often 3 or 5, can be modified) constituted by two or more concentric toothed wheels of different diameters which engage by a toothed wheel of one with the pinion of another according to the desired multiplication ratios. They are mounted on ball-bearings or roller bearings on axles fixed in a chassis or housing secured to the frame of the bicycle or of the apparatus. The latter element consists in a toothed wheel fixed on the hub of the rear wheel.

To facilitate starting up, this transmission by engagement is most often mounted in parallel with a conventional chain drive running from the pedal mechanism, on the cranks or axle of which are fixed one or several toothed plates, to the hub of the rear wheel with its corresponding free wheeling pinion or pinions and their derailers. After having achieved a sufficient speed with the conventional chain transmission, the user multiplies it by engaging the transmission according to the present invention which takes over whilst the chain transmission becomes inoperative.

Constituting new combinations to reinforce the rotation of the intermediate transmission elements by engagement, supplemental wheels or toothed crowns with single or double teeth, axially fixed on the pedal mechanism and/or on the hub of the rear wheel, can be added and engaged with toothed wheels, not secured to other toothed wheels of the corresponding element which are mounted free wheeling one way on a shoulder of said intermediate elements which can all be related by this arrangement when they coact in the direction of advance of the bicycle or the apparatus and remain neutral when the user stops pushing on the pedals.

A clutch mechanism couples or uncouples, at the choice of the user, the toothed wheels of a same engagement element, most often intermediate, actuated or de-actuating the transmission according to the present invention.

Thus, as an example of new combinations axially fixed on the pedal mechanism:
A supplemental toothed wheel secured and fixed to the toothed wheel constituting the first element of the transmission by engagement can engage with a toothed wheel on the axle and mounted with a one way free wheel on a shoulder of the second element.
A supplemental toothed wheel secured and fixed to the axle/crank assembly can engage with a toothed wheel axially mounted on and free wheeling in one direction on a shoulder of the second element of the transmission by engagement.
A supplemental crown, with single or double teeth, secured and fixed to the axle/crank assembly can engage with toothed wheels mounted free wheeling in a single direction on shoulders of the third and fourth elements (such a crown can permit doubling the speed of rotation of the kinematic engagement chain).

Symmetrically, as examples of new combinations axially fixed on the hub of the rear wheel:
A supplemental toothed wheel secured and fixed to the fixed toothed wheel constituting the last element of the transmission by engagement, can engage with a centered toothed wheel and mounted with a free wheel of the reverse direction type on the shoulder of the next to last element.
A supplemental toothed wheel secured and fixed to the toothed wheel on the free wheel bearing the chain, can engage with a centered toothed wheel mounted with a free wheel of the one way type on a shoulder of the next to last element of the transmission by engagement.
A supplemental crown, with single or double teeth, secured and fixed to the toothed wheel on the free wheel bearing the chain, can engage with toothed wheels mounted with free wheels of the one way type on shoulders of the sixth and/or seventh elements of the transmission by engagement.

To specify the operation of the assembly of these new combinations, when the user presses on the pedals in the forward direction: for input, this power actuates the series of elements of the transmission by engagement from the first element which actuates the series of intermediate multiplying elements (the action of the toothed wheels and/or the supplemental crowns having the effect of reinforcing the movement of the intermediate elements) until the last element, the engagement fixed on the hub of the rear wheel, which, under the motor effect of this combined mechanical transmission, increases its movement, and, for output, the speed acquired and the lever effect of the rear wheel restores a great part of the power which passes through the series of multiplying engaging elements in the reverse direction, frees the first element from engagement by the effect of its free wheel on the axle of the pedal mechanism, relieves the necessary pressure on the pedals and to this extent facilitates pedaling . . . thus, the continued pressure on the pedals in the forward direction creates a kinematic input-output chain in which the recycling of the energy renders the following turns easier and easier . . . and the increase of speed can take place as the user wishes.

According to the adopted combination, a bicycle provided with the mechanical transmission according to the invention can reach and greatly exceed 100 km/hour, while arrangements having been made, in addition to the personal equipment of the user, to ensure the safety, particularly by adapting the wheels, the frame, with reinforcements and shock absorbers, and the braking system, such that they be suitable for such speeds.

According to standards, the required performances and the size of the locomotion apparatus which moves it, this combined mechanical transmission with input-output is modifiable, particularly as to the following points:
Transmission elements: According to the distance of the pedal mechanism to the rear wheel and the selected ratios, their number, their dimensions, the number of concentric toothed wheels on a same element, their diameter, their modulus and their arrangement are modifiable. The intermediate transmission elements can turn on fixed axles or be fixed on axles rotating in bearings fixed on the chassis. Each element can receive on a shoulder, mounted with a free wheel, one or several toothed wheels that are not secured to other toothed wheels.
Train transmission: Although the chain transmission will often be necessary for starting up, it is possible to omit it, in which case the clutching will not be needed.
Clutching mechanism: Actuated by cable and/or lever, manually or electromechanically, it could be made with claws, projections and grooves, jaws, pulleys and belts or by any other mode of coupling in a manner adapted to one or the other of the axial positions of the transmission elements.
Number of transmission mechanisms combined per location apparatus: It is possible to have the transmission on one of its sides or each side of the pedal mechanism, or to have a central transmission with pedaling from each side.
Supplemental toothed crowns and wheels: their diameter can vary according to the increase of power that is sought and they could be single or double toothed. Generally fixed to the chain plate of the pedal mechanism or to the pinion on the free wheel of the rear wheel, they could also be separated from it and mounted on the free wheel on an axle of the front pedal mechanism or fixed on the rear hub. They could also be centered on intermediate elements.
The chassis with which are connected the axles of the intermediate elements of the transmission by engagement could be fixed at several points on the frame of the cycle and also connected to the hub of the rear wheel by needle bearings or ball-bearings and permit, by a suitable device, the easy separation of the rear wheel from the rest of the cycle. The assembly of the mechanism can receive a protective envelope or casing to isolate it from the external medium.
The materials used can be of different natures.

The present invention relates to a mechanical transmission between the pedal mechanism and the rear wheel of a pedaled vehicle, usable for a cycle, characterized by the fact that it comprises:
a toothed wheel mounted free wheelingly in a single direction on the axle of the pedal mechanism such that the pedal mechanism drives by its rotation in the forward direction;
an engagement element fixed securely on the hub of the rear wheel;
intermediate means for the transmission of power between the toothed wheel and the engagement element adapted to multiply the speed of rotation from the toothed wheel to the engagement element.

According to modifications:
the power transmission means are constituted by a series of intermediate elements formed by pairs of concentric toothed wheels of different diameters, the largest diameter toothed wheel of a pair engaging with the smallest toothed wheel of the following pair, the smallest diameter toothed wheel of the first pair engaging with the toothed wheel, the toothed wheel of largest diameter of the last pair engaging with the engagement element.
it comprises a clutch device for the transmission means of power for their control and actuation.
it comprises a parallel drive system comprising at least one plate secured to the pedal mechanism, at least when pinion mounted by a free wheel on the rear wheel and a chain connecting the plate and the pinion.
it comprises at least one wheel or at least one toothed crown mounted about the axle of the pedal mechanism, coacting with the power transmission means to complete their drive.
the supplemental toothed wheel or crown or crowns or wheels centered on the pedal mechanism is secured to the wheel and engages with a toothed wheel mounted of the free wheel type of a single direction, on a shoulder of an intermediate element.
the supplemental toothed wheel or wheels and/or crown or crowns centered on the pedal mechanism is fixed to the pedal mechanism and secured to a plate and/or to the toothed wheel bearing the chain, the said supplemental toothed wheel or wheels and/or crown or crowns engaging with a toothed wheel mounted free wheelingly in a single direction on a shoulder of an intermediate element.
it comprises one or several supplemental toothed wheels and/or crowns, centered on the hub of the rear wheel, and secured to the toothed wheel, said supplemental toothed wheel or wheels and/or crown or crowns engaging with toothe wheels mounted free wheelingly in a single direction on a shoulder of an intermediate element or elements.
it comprises one or several supplemental toothed wheels or crowns centered on the hub of the rear wheel, and fixed on a plate and/or the pinion driven by the chain which turns free wheelingly, the said supplemental toothed wheel or wheels and/or crown or crowns engaging with toothed wheels mounted free wheelingly in a single direction on a shoulder of one or more of the intermediate elements.

The invention also relates to small cars, small boats and other pedaled apparatus, characterized in that they are provided with one or several transmissions according to any one of the preceding claims.

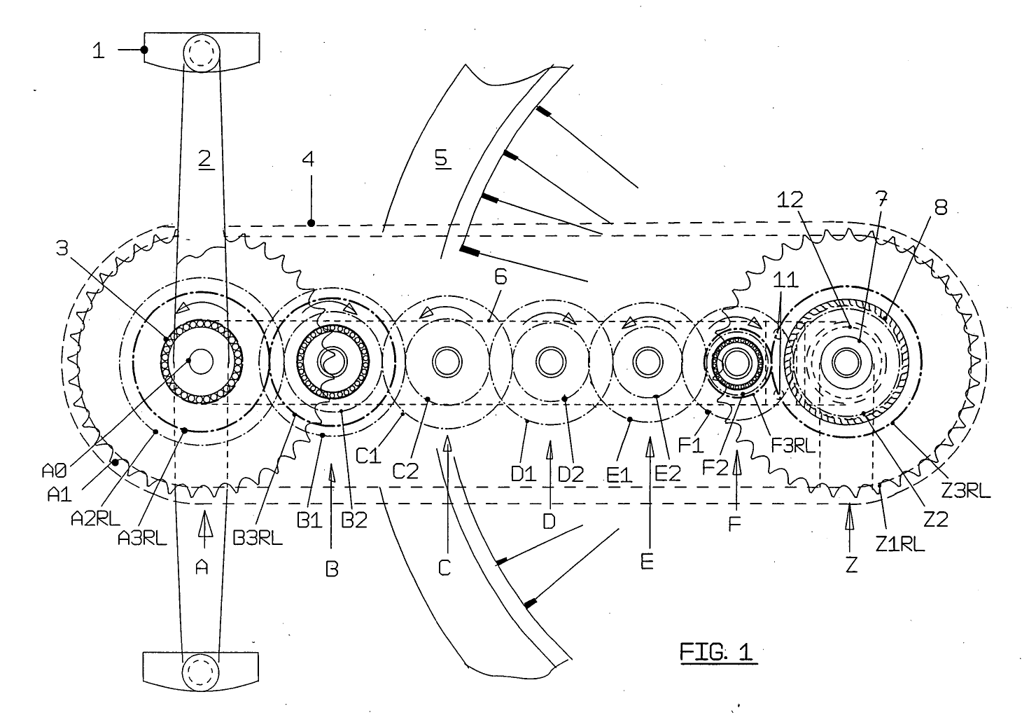

The accompanying drawings show, without being limiting, the elevational views of four embodiments of combined transmission mechanism for input-output according to the invention, associating a conventional chain transmission with a series of 7 transmission elements by multiplying engagement with supplemental toothed wheels and crowns; for clarity of FIGS. 1-4, no clutch mechanism is shown, the fifth figure showing this:

FIG. 1 shows such a combination reinforced with two supplemental toothed wheels: one secured to the first element on the axle of the crank mechanism and the other secured to the free wheeling toothed wheel bearing the chain on the hub of the rear wheel.

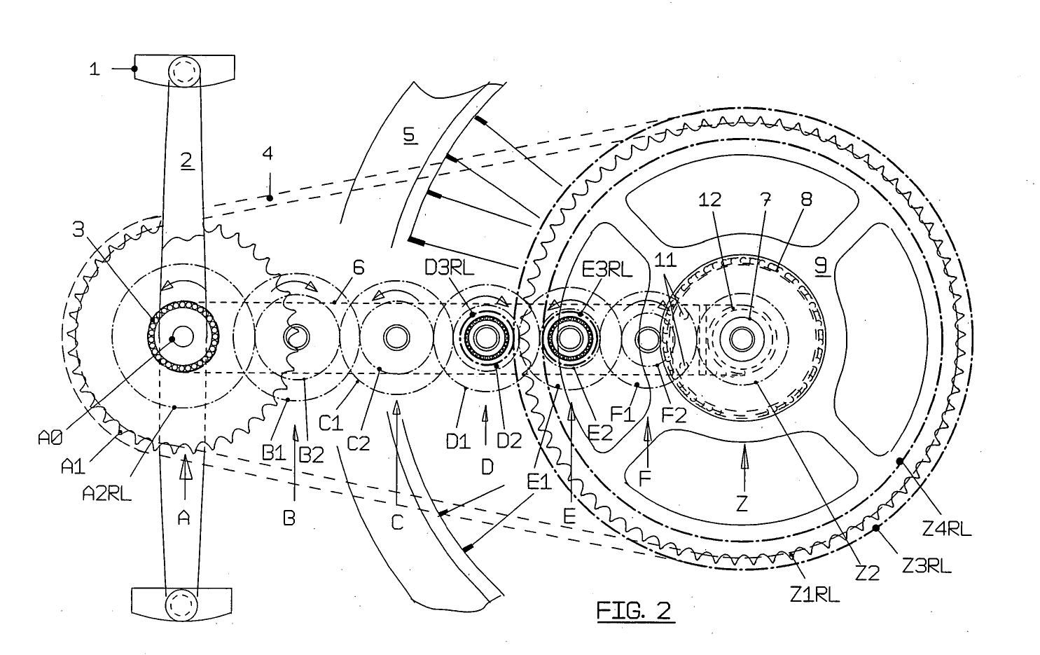

FIG. 2 shows such a combination reinforced with a supplemental double toothed crown secured to the toothed wheel on the free wheel of large diameter bearing the chain on the hub of the rear wheel.

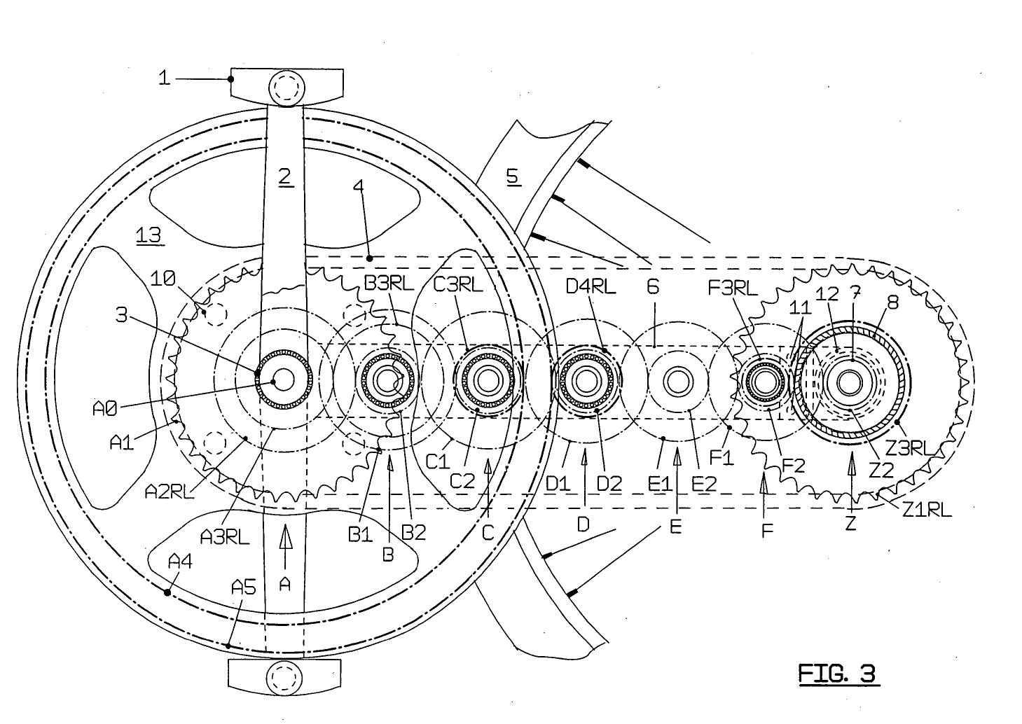

FIG. 3 shows such a combination reinforced with two supplemental toothed wheels, one secured to the first engagement element on the axle of the pedal mechanism and the other secured to the toothed wheel that free wheels carrying the chain on the hub of the rear wheel, and a double toothed crown of large diameter secured to the pedal mechanism.

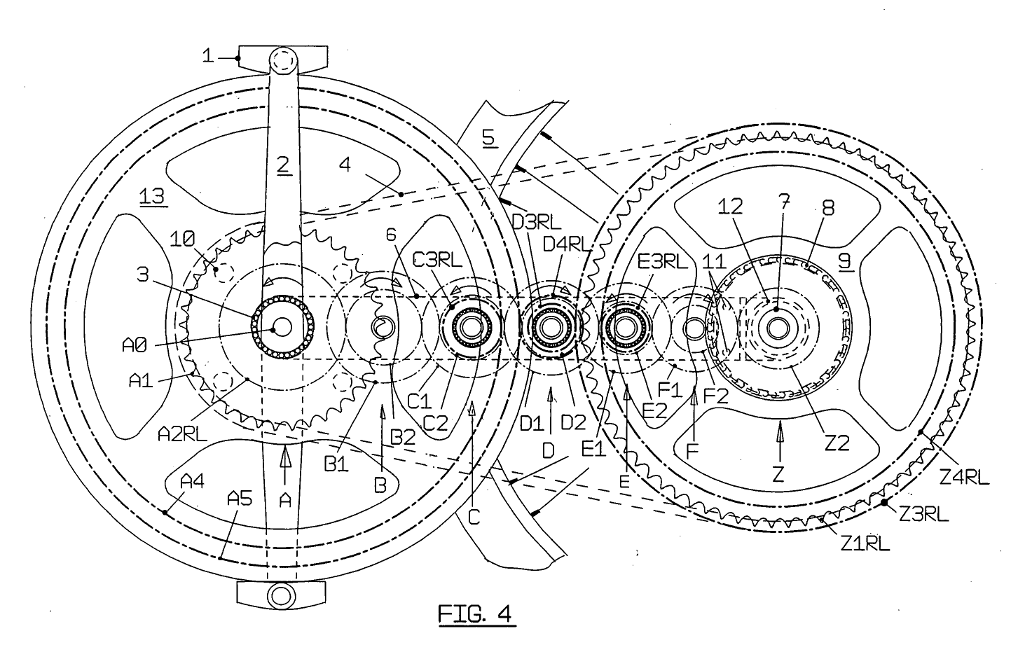

FIG. 4 shows a design of such a combination associating the supplemental toothed crowns and wheels of the preceding figures.

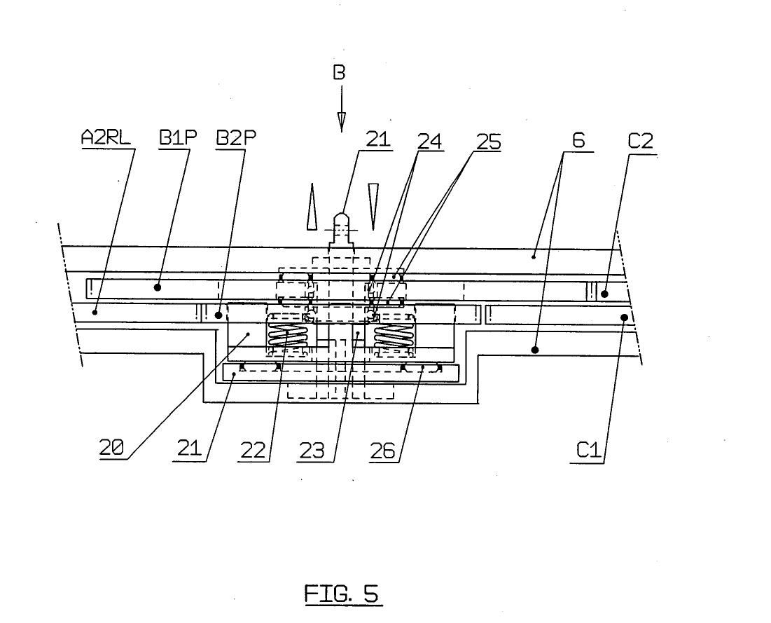

FIG. 5 shows an example of a toothed clutching mechanism.

With reference to these designs and particularly to FIG. 1, the mechanism comprises a series of seven transmission elements in combination, going from (A) to (Z) and passing through (B), (C), (D), (E), (F). The first transmission element (A) carries the pedal mechanism constituted by pedals (1) and cranks (2) fixed on its axle (A0) which drives in parallel, by turning in the direction of forward movement of the bicycle, an engagement element constituted by two toothed wheels (A2RL-A3RL) secured to each other and mounted on a free wheel of the single direction type (3) which leaves free the rotation of the pedal mechanism in the other direction—(the term RL added to the reference indicates that the engagement is mounted on a free wheel of the single direction type). The toothed plate (A1) secured to the axle (A0) and to the crank (2), transmits by a chain (4), the pressure applied to the pedals to the toothed wheel (Z1RL) mounted on a free wheel of the single direction type (8) fixed on the hub (7) of the rear wheel (5). Mounted on roller bearings about the fixed axles on a chassis (6), the intermediate transmission elements (B), (C), (D), (E), (F) are constituted by engagements which engage the toothed wheel of one with the pinion of the other in a ratio such that the rotation is multiplied in a direction from the pedal mechanism toward the rear wheel. For greater precision, although the toothed wheel (A3RL) drives the toothed wheel (B3RL), the toothed wheel (A2RL) drives the pinion (B2) and multiplies the speed of rotation of the intermediate transmission element (B), the multiplying engagement element constituted by the concentric toothed wheels (B1-B2) secured together and (B3RL) which is mounted on a free wheel of the single direction type on a shoulder of the assembly (B1-B2), in which the toothed wheel (B1) engages with the pinion (C2) and multiplies the speed of rotation of the intermediate transmission element (C), the multiplying engagement element constituted by the concentric toothed wheels (C1-C2) secured together in which the toothed wheel (C1) engages with the pinion (D2) and multiplies the speed of rotation of the intermediate transmission element (D), the multiplying engagement element constituted by the concentric toothed wheels (D1-D2) secured together in which the toothed wheel (D1) engages with the pinion (E2) and multiplies the speed of rotation of the intermediate transmission element (E), the multiplying engagement element constituted by the concentric toothed wheels (E1-E2) secured together in which the toothed wheel (E1) engages with the pinion (F2) and multiplies the speed of rotation of the intermediate transmission element (F), the multiplying engagement element constituted by the concentric toothed wheels (F1-F2) secured together and (F3RL) which is mounted one-way free wheelingly on a shoulder of the assembly (F1-F2), in which the toothed wheel (F1) engages with the toothed wheel (Z2) of the last transmission element (Z) constituted by the engagement (Z2) secured to the rear wheel (5) and fixed on its hub (7) and, in parallel, the toothed wheel (Z3RL)—secured to the toothed wheel (Z1RL) carrying the chain—which engages with the toothed wheel (F3RL). The disassembly of the rear wheel is facilitated by the disjunction of the bearing (12) of the chassis (6) at a device (11). The chassis (6) is fixed to the frame of the bicycle on the pedal mechanism side and it can also be fixed on an arm of the fork supporting the rear wheel. When the user exerts a pressure of the feet on the pedals (1) and the transmission according to the invention is engaged, the rear wheel (5) is by input caused to increase its movement of rotation by the action of the series of intermediate multiplying engagement elements driven by the toothed wheel (A2RL) back to the rear wheel (Z2) and by the reinforcing action of the toothed wheels (A3RL) and (Z3RL); by turning, the rear wheel (5), by is acquired speed and its lever effect on the toothed wheel (Z2) actuates for output the series of engagement elements up to the toothed wheel (A2RL), which, by the effect of the free wheel (3), frees the axle (A0), relieves the pedaling and permits increasing to this extent the speed in the kinematic chain of input-output. The assembly of the engagement elements and the associated chassis can be protected by a covering or by a housing (not shown). The clutch device of the transmission shown in FIG. 5 can be adapted to one of the axial positions (C), (D), or (E).

With reference to the drawing of FIG. 2, the modifications of the combination described in FIG. 1 are as follows: The reinforcement constituted by the engagement of the toothed wheels (A3RL) and (B3RL) is omitted as well as the pinion (F3RL). On the contrary, the transmission element (Z) is modified by the securement on a plate (9) mounted on the free wheel (8), of a toothed wheel supporting the chain (Z1RL) of a greater diameter and by a double toothed crown (Z3RL-Z4RL), which, by engaging with the toothed wheels (D3RL) and (E3RL) mounted free wheelingly on the shoulder of the respective intermediate engaging elements (D1-D2) and (E1-E2), reinforce the kinematics of the transmission, particularly during engagement of the transmission by the device shown in FIG. 5 which can, in this design, be adapted to one of the axial positions (B), (C), or (F).

With reference to the drawing of FIG. 3, the modification from the combination described in FIG. 1 is as follows: The transmission element (A) is modified by the securement at (10) of a plate (13) on the toothed wheel supporting the chain (A1) secured to a supplemental double toothed crown (A4-A5), which, by engaging respectively with the toothed wheels (C3RL) and (D4RL) mounted free wheelingly on a shoulder of the intermediate engaging elements, respectively (C1-C2) and (D1-D2), reinforce the kinematics of the transmission to further double the forward speed already multiplied relative to the present speeds. The clutch device of the transmission shown in FIG. 5 can be particularly adapted to the axial position (E).

With reference to FIG. 4, this elevational view shows a design of transmission which combines the elements described in the three preceding figures and associates the power of a supplemental double toothed crown (A4-A5) on the pedal mechanism which increases the speed to facilitate the starting of a supplemental double toothed crown (Z3RL-Z4RL) on the hub of the rear wheel. The clutch device of the transmission shown in FIG. 5 can be adapted to one or the other of the axial positions (B) or (F).

The drawing of FIG. 5 shows a plan view of a design of a clutch with teeth that can adapt to different axial positions but here is referenced relative to the axle B of FIG. 2. The transmission according to the invention is clutched by traction on the axle (21) whose disc bears by means of a needle abutment (26) on a second disc (20) carrying teeth which sink through the pinion (B2P) and penetrate into the recesses of the toothed wheel (B1P) of the engagement element (B). Ball abutments (24) and rollers (25) facilitate the relative movements about the axle (23) which is fixed in the chassis (6). When the user relaxes traction on the axle (21), sliding within the axle (23), the springs (22) extend and the transmission is unclutched.

Particularly adapted for the bicycle industry, particularly to all sizes and types of pedal bicycles with normal wheels or smaller, where it permits, by reinforcement of the speed and economy of power realized, a design of reduced size and better adaptation to urban regions, the transmission mechanism with combined input-output according to the invention can also be adapted to other locomotion devices with pedals, particularly small cars and boats with blades or screws.

### References

1. Pedal
2. Crank
3. Free wheel
4. Chain
5. Rear wheel
6. Chassis
7. Hub
8. Free wheel
9. Plate
10. Securement point
11. Device
12. Bearing
13. Plate

1-10 (cancelled).

11. Mechanical transmission between the pedal mechanism (A0) and the rear wheel (5) of a pedaled vehicle, usable for a bicycle, comprising:
a toothed wheel (A2RL) mounted as a freewheel one way (3) on the axle of the pedal mechanism (A0) so that the pedal mechanism (A0) drives it in rotation in the forward direction;
an engagement element (Z2) fixed securely on the hub (7) of the rear wheel;
intermediate power transmission means between the toothed wheel (A2RL) and the engagement element (Z2), wherein the power transmission means are constituted by a series of intermediate elements (B, C, D, E, F) formed by pairs of concentric toothed wheels of different diameter, the toothed wheel of largest diameter of a pair engaging with the toothed wheel of smallest diameter of the following pair, the smallest diameter toothed wheel (B2) of the first pair (B) engaging with the toothed wheel (A2RL), the toothed wheel of the largest diameter (F1) of the last pair (F) engaging with the engagement element (Z2), to multiply the speed of rotation from the toothed wheel (A2RL) to the engagement element (Z2).

12. Transmission according to claim 11, wherein the transmission comprises a clutching device for the power transmission means for controlling their actuation.

13. Transmission according to claim 11, wherein the transmission comprises a parallel drive system comprising at least one plate (A1) secured to the pedal mechanism, at least one pinion (Z1RL) mounted as a freewheel (8) on the rear wheel (5) and a chain (4) connecting the plate (A1) and the pinion (Z1RL).

14. Transmission according to claim 11, wherein the transmission comprises at least one wheel or at least one toothed crown mounted about the axle of the pedal mechanism (A0), coacting with the power transmission means to complete their drive.

15. Transmission according to claim 14, wherein at least one of the at least one supplemental toothed wheel and at least one crown centered on the pedal mechanism is secured to the wheel (A2RL) and engages with a toothed wheel mounted z of the one-way type (B3RL, Z3RL, D4RL) on a shoulder of an intermediate element.

16. Transmission according to claim 15, wherein the at least one supplemental toothed wheel or at least one crown centered on the pedal mechanism is fixed to the pedal mechanism (A0) and secured to a plate (13) and/or to the toothed wheel (A1) bearing the chain (4), said supplemental toothed wheel or wheels and/or crown or crowns engaging with a toothed wheel mounted as a one-way freewheel (D3RL, Z3RL, D4RL) on a shoulder of an intermediate element.

17. Transmission according to claim 11, wherein the transmission comprises at least one supplemental toothed wheel or crown, centered on the hub of the rear wheel (5), and secured to the toothed wheel (Z2), the supplemental toothed wheel or wheels and/or crown or crowns engaging with one-way free wheeling toothed wheels (F3RL, E3RL, D3RL) on a shoulder of one or more intermediate elements.

18. Transmission according to claim 13, wherein the transmission comprises at least one supplemental toothed wheel or crown centered on the hub of the rear wheel (5), and fixed on a plate (9) and/or the pinion (Z1RL) driven by the chain (4) which turns on the free wheel (8), the at least one supplemental toothed wheel or crown engaging with one-way free wheeling toothed wheels (F3RL, E3RL, D3RL) on a shoulder of one or more intermediate elements.

19. A pedaled apparatus, comprising at least one transmission according to claim 1.

20. A pedaled apparatus, comprising at least one transmission according to claim 12.

21. A pedaled apparatus, comprising at least one transmission according to claim 13.

22. A pedaled apparatus, comprising at least one transmission according to claim 14.

23. A pedaled apparatus, comprising at least one transmission according to claim 15.

24. A pedaled apparatus, comprising at least one transmission according to claim 16.

25. A pedaled apparatus, comprising at least one transmission according to claim 17.

26. A pedaled apparatus, comprising at least one transmission according to claim 18.
